(19) United States
(12) Patent Application Publication
(10) Pub. No.: US 2009/0071971 A1
(43) Pub. Date: Mar. 19, 2009

(54) SECURE MEDICATION DISPENSATION MECHANISM

(75) Inventors: John F. JOHNSTON, Paris (CA); Arnold STOLL, Kitchener (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: GRAFTON CANADA LIMITED, Paris (CA)

(21) Appl. No.: 12/109,814

(22) Filed: Apr. 25, 2008

Related U.S. Application Data
(60) Provisional application No. 60/913,907, filed on Apr. 25, 2007.

(51) Int. Cl. G07F 11/50

(52) U.S. Cl. 221/1; 211/131.1; 221/119

(57) ABSTRACT

The invention provides a mechanism for dispensing items such as medication. The mechanism includes a carousel assembly, housing a plurality of storage compartments, which sits within a tray base. The tray base only allows one compartment to be opened at a time. The carousel assembly is associated with a motor which rotates the carousel assembly so that a requested storage compartment is accessible by a user. After the user has retrieved the item or items from the storage compartment, a trigger mechanism signals the motor to rotate the carousel assembly to automatically close the storage compartment so that others can not access the contents and to secure the contents.

### CROSS-REFERENCE TO RELATED APPLICATIONS

This application claims the benefit of U.S. Provisional Application No. 60/913,907, filed Apr. 25, 2007, which is incorporated herein by reference.

### FIELD OF THE INVENTION

This invention relates to dispensing mechanisms, and more particularly to a method and apparatus for dispensing materials, such as medication.

### BACKGROUND OF THE INVENTION

In the field of medication dispensing, one concern is that medication is not administered by the designated individuals or that access to medication is not secure. This is especially true when it comes to nurses who are administering medication to patients in a hospital. Typically, the medication is placed in a container and then brought to the individual patients. However, while the nurse is administering medication to one individual, the medication for other patients is accessible by any person walking past the medication holder. This results in unauthorized possession of medication.

Therefore, there is provided a novel method and apparatus for securely storing and dispensing materials, such as medication.

### SUMMARY OF THE INVENTION

The invention provides a novel mechanism for dispensing items such as medication. The mechanism includes a carousel assembly, housing a plurality of storage compartments, which sits within a tray base. The tray base only allows one compartment to be opened at a time. The carousel assembly is associated with a motor which rotates the carousel assembly so that a requested storage compartment is accessible by a user.

After the user has retrieved the item or items from the storage compartment, a trigger mechanism signals the motor to rotate the carousel assembly to automatically close the storage compartment so that others can not access the contents and to secure the contents.

In one aspect of the invention, there is provided a carousel-type bin structure, having a plurality of bins arranged around a central axis, with only one bin being openable at any time, when aligned radially with a radial opening, including motor and control means for rotating the carousel to position a selected bin for opening, or to position the bins so that no bin is properly aligned with the opening, all bins thus being locked.

In another aspect, there is provided apparatus for dispensing items comprising a plurality of storage compartments; a carousel assembly for housing the plurality of storage compartments arranged around a central axis, whereby only one of the plurality of storage compartments can be open at one time; a motor for rotating the carousel assembly; and a trigger mechanism for transmitting a signal to the motor to rotate the carousel assembly to close an open storage compartment.

In yet a further embodiment, there is provided a method of dispensing items comprising receiving a signal to open a requested storage compartment; rotating a carousel assembly, including a plurality of storage compartments, so that the requested storage compartment is in an open position; sensing a trigger signal indicating that the requested storage compartment should be closed; and closing the requested storage compartment.

### BRIEF DESCRIPTION OF THE DRAWINGS

Embodiments of the present invention will now be described, by way of example only, with reference to the attached Figures, wherein:

FIG. 1 is a perspective view of an apparatus for dispensing materials;

FIG. 2a is a perspective view of a carousel assembly;

FIG. 2b is a bottom view of the carousel assembly;

FIG. 3 is perspective view of a storage compartment located within the carousel assembly;

FIG. 4 is a perspective view of a motor tray base without a switch assembly;

FIGS. 5 to 7 are various view of the carousel assembly mounted to the motor tray base;

FIG. 8 is a partial bottom view of motor tray base;

FIG. 9 is another perspective view of the motor tray base with a switch assembly;

FIG. 10 is a perspective view of a switch;

FIG. 11 is a bottom view of the bottom carousel plate;

FIG. 12 is a flowchart outlining a method of dispensing materials; and

FIG. 13 is a perspective view of the mechanism including a cover.

### DETAILED DESCRIPTION

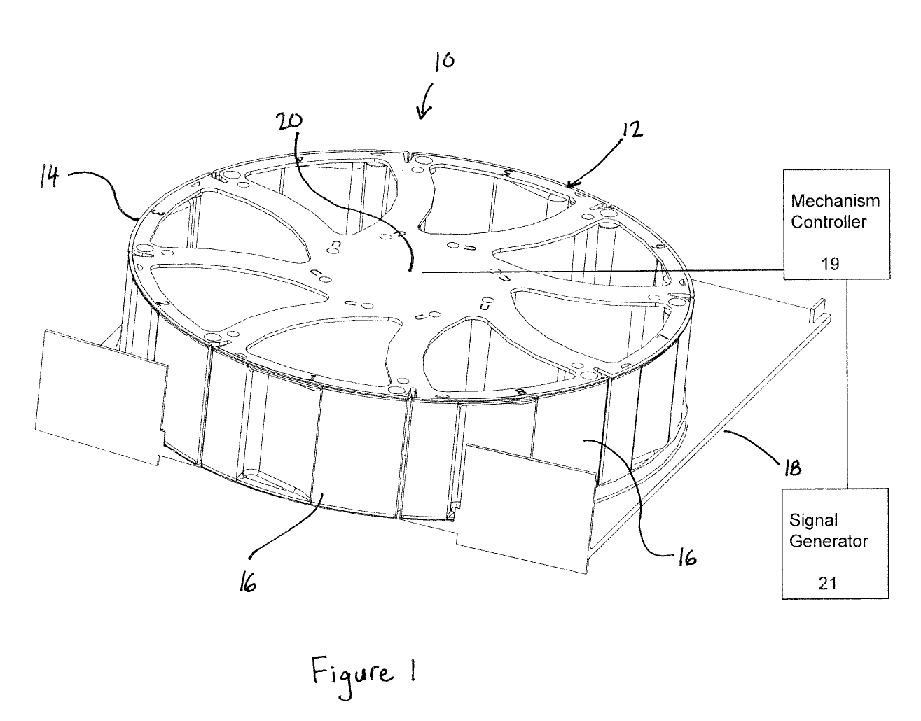

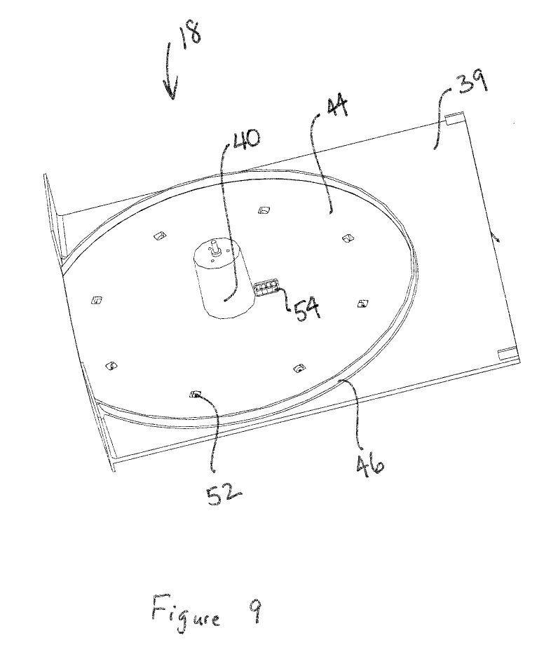

Turning to FIG. 1, a perspective view of a mechanism, or apparatus, for dispensing items, such as medication, is shown. The mechanism 10 includes a storage and dispensing container 12, seen as a carousel assembly 14, having a plurality of storage compartments 16. Each storage compartment 16 is located within a specific location within the carousel assembly 14 and is individually identified, or designated. For instance, if there are eight compartments, the storage compartments are identified as compartments 1 to 8. The identification of each storage compartment allows a user to specifically request a storage compartment to be accessible instead of having to check each compartment to determine the individual contents. The carousel assembly 14 is housed within a motor tray base 18 atop which a motor (not shown) is located. In the current embodiment, the motor is located within a central axis 20 of the carousel assembly 14 and rotates the carousel assembly 14 so that a requested storage compartment 16 is placed in an open position and accessible by a user. As will be described below, only one storage compartment can be opened at any time. The mechanism 10 further includes a switch assembly, shown and described in FIG. 9, which monitors and tracks the location of the storage compartments with respect to the tray base 18. The mechanism 10 is controlled by a mechanism control, or controller, 19 which receives signals from a signal generator 21, such as a controller or a processor. In the preferred embodiment, the controller 21 is connected to the mechanism control 19 via a USB cable but as will be understood, communication between the mechanism controller 19 and the signal generator 21 can also be wireless. The mechanism controller 19 is in communication with the motor and the switch assembly. Although not shown, the mechanism 10 is preferably powered by a battery so that the unit is portable, however, it can also be powered by a power cord for a stationary unit or a unit which is located on a cart.

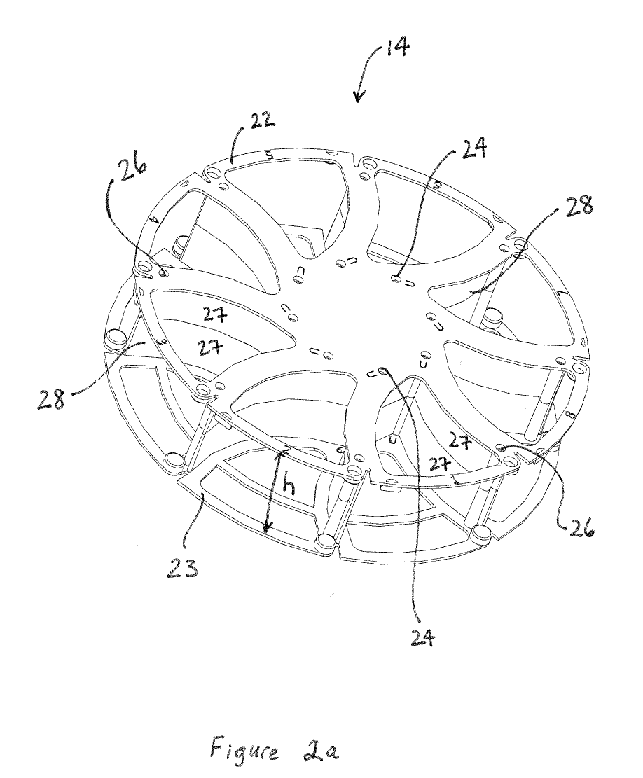

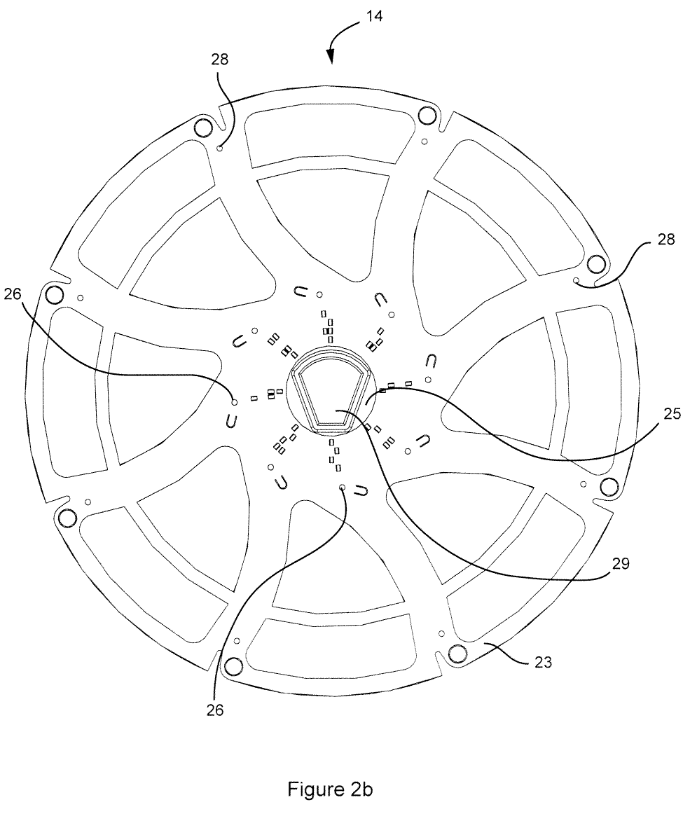

In one embodiment of the carousel assembly 14, as shown in FIG. 2a, the assembly 14 includes a top carousel plate 22 and a bottom carousel plate 23, separated by a height, h. In the preferred embodiment, h is equal to five inches and the diameter of each plate 22 and 23 is eighteen (18) inches. However, as will be understood, other dimensions for the height and diameter are possible. The two plates 22 and 23 are connected together via a plurality of attachment points, seen as inner attachment points 24 and outer attachment points 26. The inner 24 and outer 26 attachment points also define the edges of a plurality of walls 28 which provide locations within the carousel assembly 14 for the storage compartments 16.

In the current embodiment, both of the plates include a partition portion 27. The partition portions 27 include means for attaching with corresponding partition portions on the other plate to form the walls 28. In another embodiment, the inner 24 and outer 26 attachment points can be implemented via holes within the plates 22 and 23 which receive poles attached at both ends to the plates 22 and 23. A separator is then molded around the poles to provide the walls of the storage compartment locations. Although many materials are contemplated, the carousel assembly 14 is preferably manufactured from fiberglass. FIG. 2b is a bottom view of the carousel assembly. As can be seen, the bottom carousel plate 23 includes an opening 25 for receiving the motor while the bottom of the top carousel plate 22 includes a cap receiving portion 29 for receiving the top of the motor, or a motor cap, to assist in translating the rotation of the motor to the carousel assembly 14.

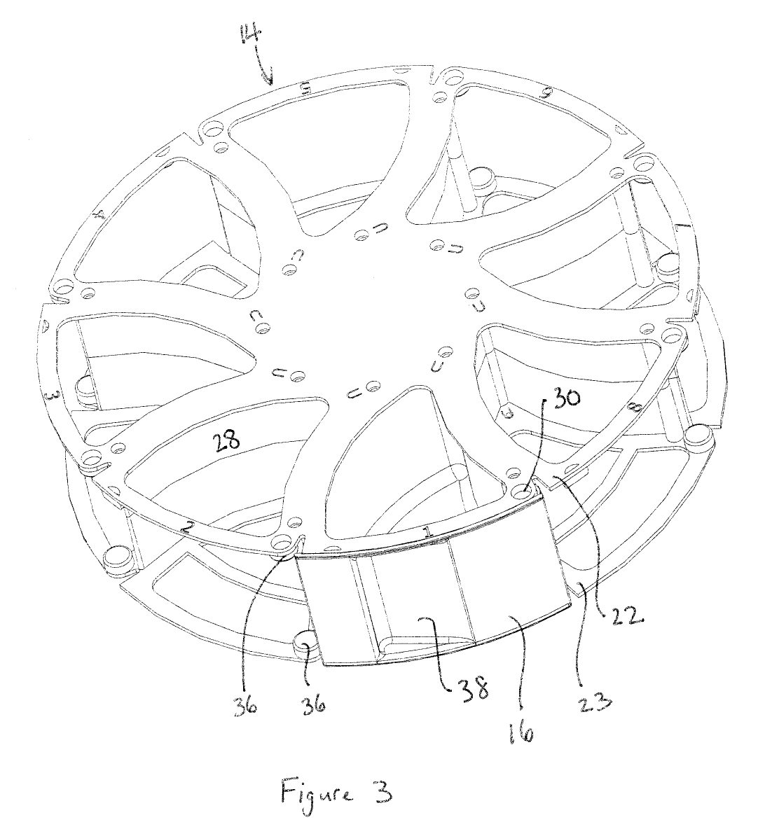

FIG. 3 provides a schematic diagram of one of the storage compartments 16 located within the carousel assembly 14. Each storage compartment 16 has an upper pivot point 30 and a lower pivot point 32 so that the storage compartment 16 can pivot between open and closed positions thereby allowing and restricting access to the contents of the storage compartment 16. In the preferred embodiment, the pivot points 30 and 32 comprise a pair of recesses (not shown) on the surface of the compartment 16 which mate with correspondingly sized dimples 36 located on both the top 22 and bottom 23 carousel plates. A handle 38 is provided on the outside of the compartment 16 so that a user can easily grip the compartment 16 to open it up for access to the contents. In an alternative embodiment, the carousel assembly 14 can include an apparatus for automatically opening the storage compartment, such as by making the compartment door spring-loaded. As will be understood, each of the compartments 16 operate independently of each other.

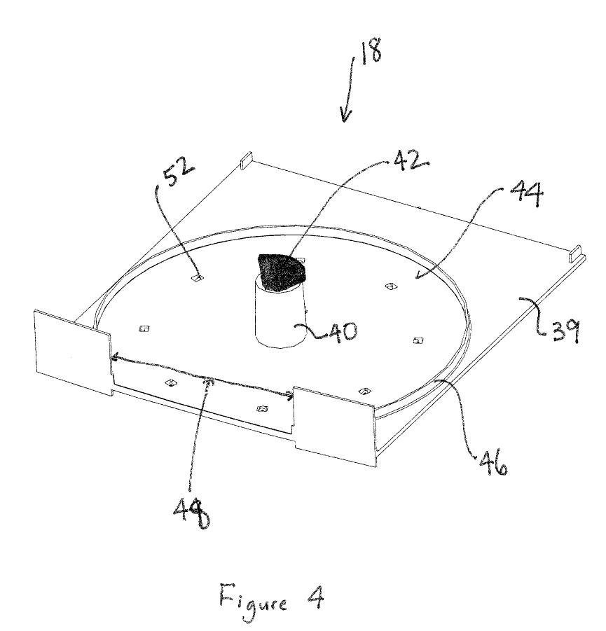

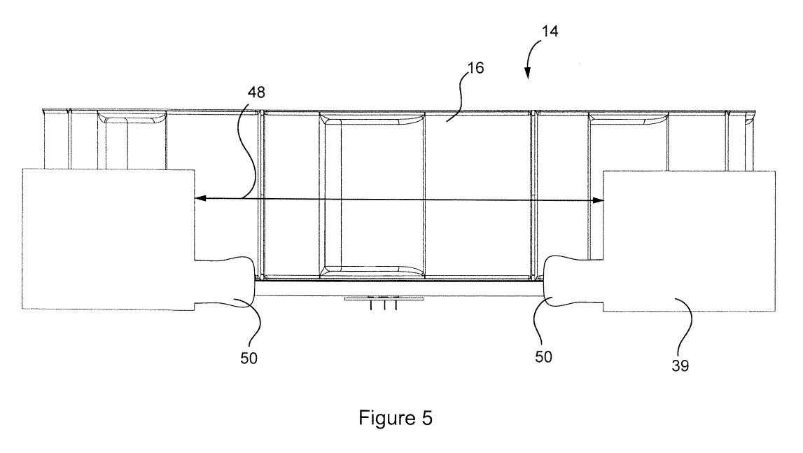

FIG. 4 is a perspective view of the motor tray base 18 without a switch assembly. The motor tray base 18, preferably manufactured from fiberglass filled nylon plastic, comprises a motor tray plate 39 which includes a planetary motor silo 40, or motor, with a drive, or motor, cap 42 located within a circular housing 44. The circular housing 44 is sized to receive the carousel assembly 14 when the mechanism is mounted together. The drive cap 42 is shaped to fit within the cap receiving portion 29 after the carousel assembly 14 has been mounted to the motor tray base 18 in order to assist in driving the carousel assembly 14 when the motor is activated. As described above, the opening 25 of the bottom carousel plate 23 is sized to fit over the motor silo 40. A lip portion 46 surrounds the circular housing 44 and serves to not only hold the assembly 14 in place (when mounted) but also to block, or lock, the storage compartments 16 from being accidently opened. The lip portion 46 also assists in closing an open storage compartment 16, as will be described below. The circular housing 44 includes an opening 48 which is designed to be the dimension required for a compartment 16 to be opened. Therefore, a storage compartment 16 can only be opened when it is fully located within the opening 48 (as shown in FIG. 5) and only one storage compartment can be opened at one time. In this manner, security is provided so that unauthorized access to the contents of a storage compartment is reduced, or prevented.

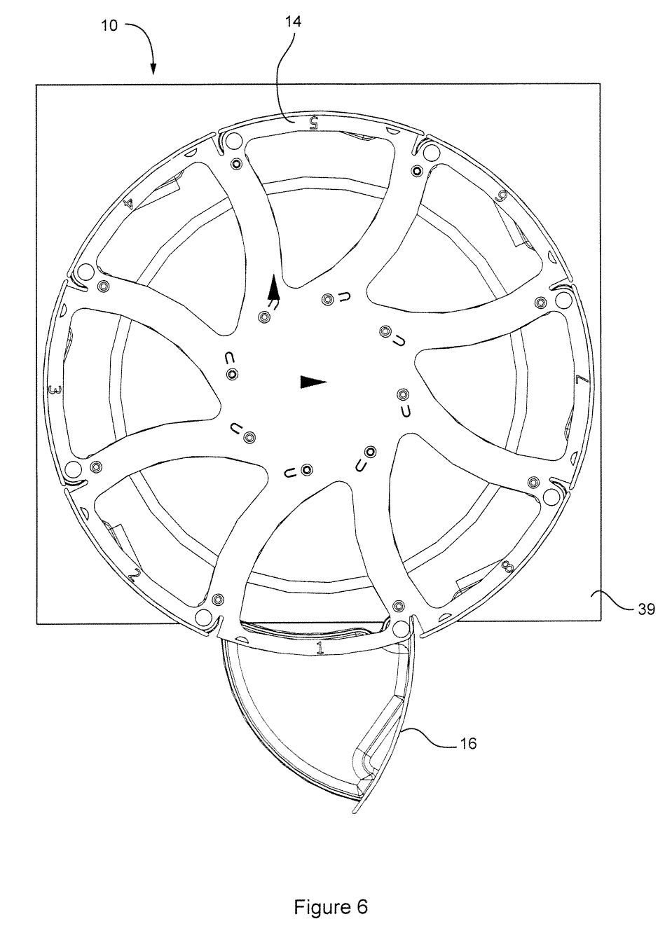

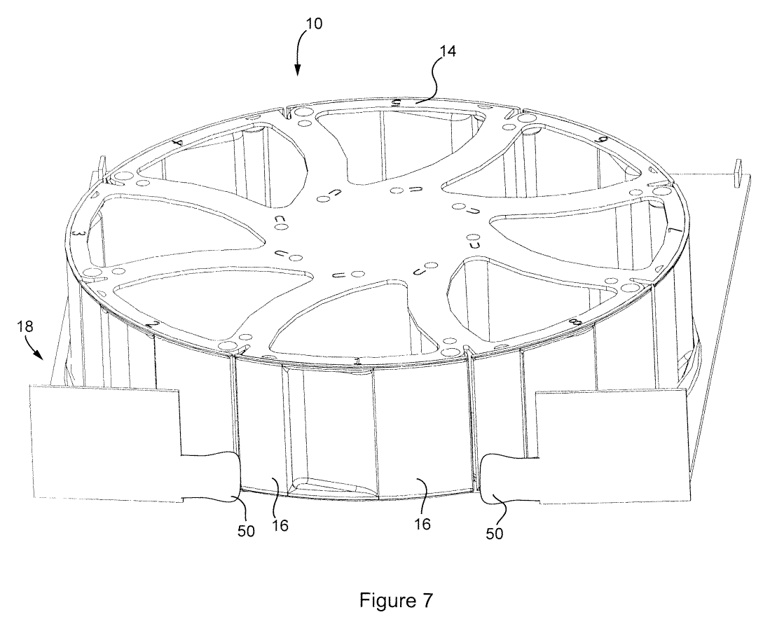

As shown in FIG. 5, in the current embodiment, adjacent the opening 48 is a pair of locking tabs 50, seen as rounded protrusions, which also assist to define the position/location, or opening 48 where a compartment 16 can be opened. As more clearly shown in FIGS. 5 to 7, the locking tabs 50 have multiple uses. When the compartments are all in the locked position (i.e. no compartment 16 is completely within the opening 48 such as shown in FIG. 7), the locking tabs 50 and the lip portion 46 are used to ensure that compartments 16 can not be accidently opened. Also, when one of the compartments is in the open position (FIG. 5 or 6) and needs to be closed, the locking tabs 50 provide adequate force to close the compartment as the carousel assembly 14 is rotated by the motor 40 so that user intervention is not required. As will be understood, in embodiments where there are no locking tabs, the lip portion 46 provides the assistance in closing the open compartment 16. Operation of the mechanism 10 will be described in more detail below.

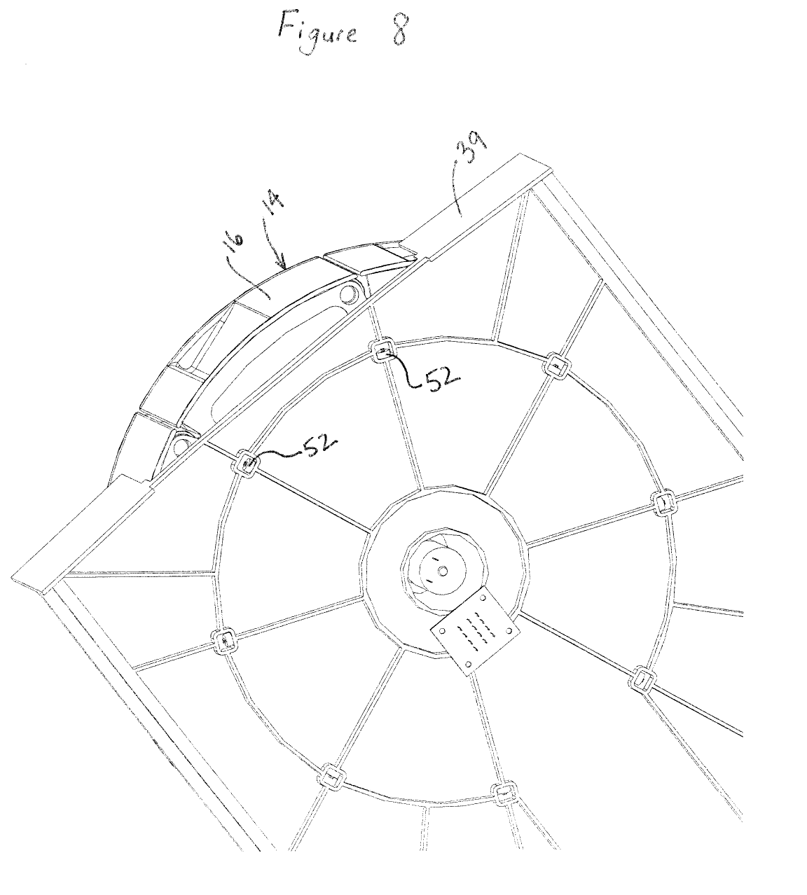

A set of wheels 52 is embedded within the circular housing 44 to assist in reducing the friction experienced by the carousel assembly 14 as the assembly is rotated by the motor 40. The set of wheels 52 is also shown in FIG. 8 which is a bottom view of the motor tray base 39.

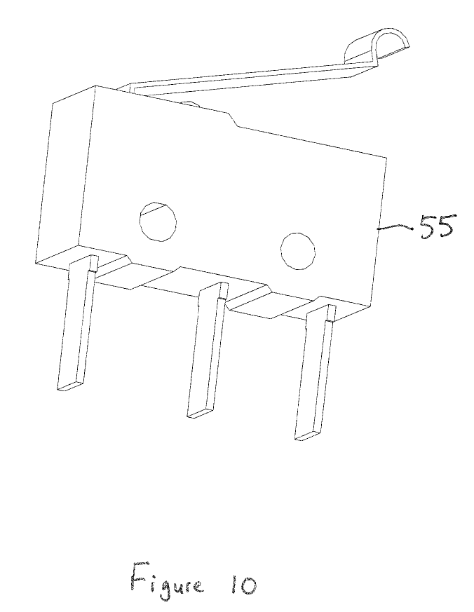

Turning to FIG. 9, the motor tray base is shown with a switch assembly. Located adjacent the motor silo 40 is a switch assembly 54, preferably digital, which is used to monitor and track when a, and which, compartment 16 is in the open position. Alternatively, the switch assembly can be an optical switch assembly or a mechanical switch assembly. In the current embodiment, the switch assembly 54 includes four separate switches 55 (shown in FIG. 10) which allows the carousel assembly 14 to include at least eight storage compartments (which is the number of compartments in the preferred embodiment).

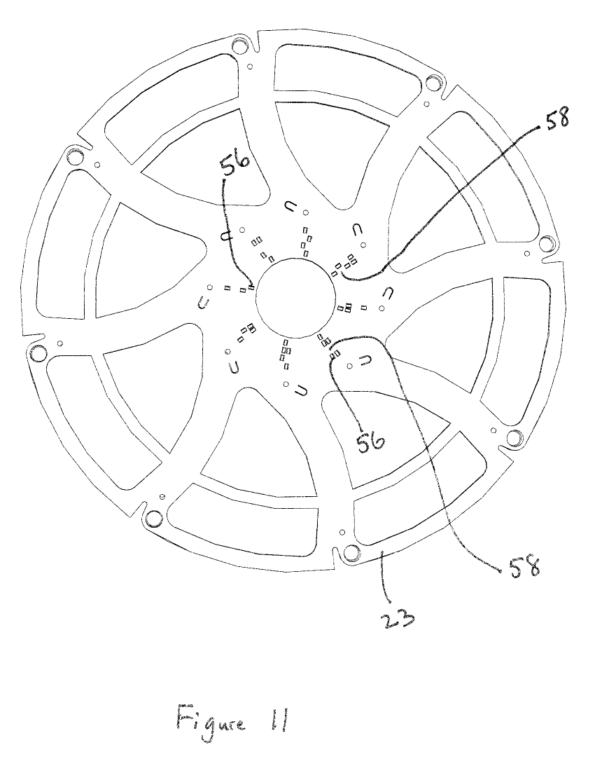

A bottom view of the bottom carousel plate is shown in FIG. 11. As can be seen, the bottom surface of the bottom carousel plate 23 includes a plurality of switch dimples 56 along with corresponding switch spaces 58. The location of the switch dimples 56 and spaces correspond with the location of sensors on the switches 55 within the switch assembly 54 which sense the dimples and spaces to provide a signal indicating the location of the carousel assembly with respect to the opening 48. The dimples 56 and spaces 58 can represent compartment identification and can represent lock position identification, as will be described in more detail below.

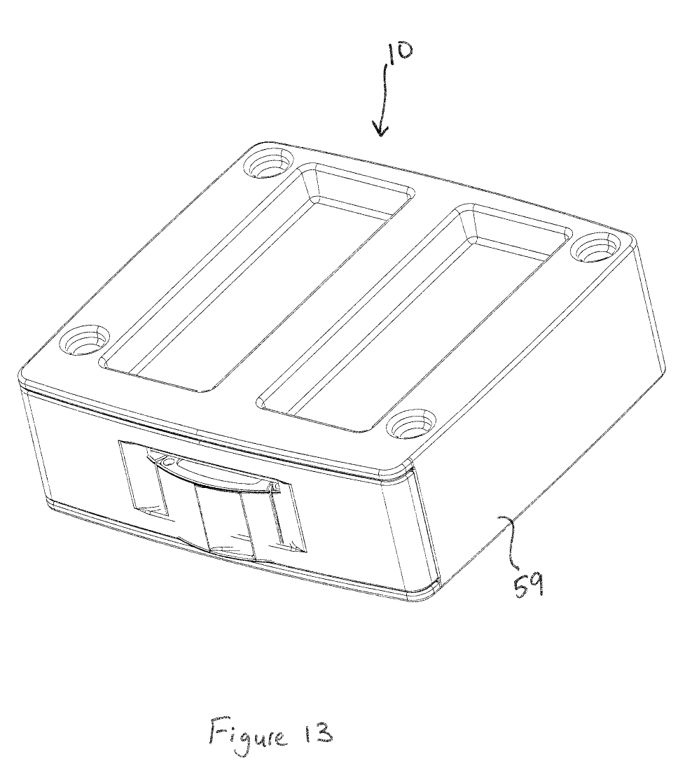

FIG. 13 is a perspective view of the mechanism including a cover 59. The cover provides added security for protecting the contents of the mechanism.

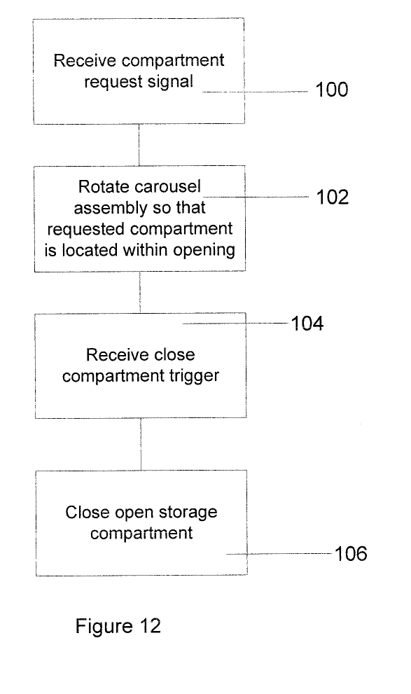

In operation, as shown in the flowchart of FIG. 12, when an individual needs to access the contents of one of the compartments, a compartment request signal is transmitted to the mechanism controller 19 of the mechanism 10 indicating which compartment needs to be opened (step 100). In one embodiment, the user accesses the controller 21 to select a compartment and the compartment request signal is transmitted by the controller 21 to the mechanism control 19. In another embodiment, the controller 21 receives the requested storage compartment information from a bar code scanner which scans a bar code associated with one of the storage compartments 16 to determine the requested storage compartment. In yet another embodiment, the requested compartment information is transmitted to the signal generator 21 from a radio-frequency identification (RFID) scanner after receiving the information from an RFID chip.

In an alternative embodiment, especially in the field of dispensing medication, the controller 21 can monitor the activity of the dispensing mechanism to determine information such as, but not limited to, which users are accessing the mechanism, the remaining items left in a storage compartment, the patient to whom the medication is being administered and the dosage of items within a compartment. In essence, the controller 21 can also function as a patient database and/or a storage compartment usage tracking database.

In the preferred embodiment, there is a digital handshake between the mechanism control 19 and the signal generator 21 so that other signal generators can not be used to circumvent the security measures.

After the user enters an identification of the requested compartment into the processor 21, the compartment request signal is transmitted. After receiving the compartment request signal, the mechanism control 19 determines the current location of the carousel assembly 14 by communicating with the switch assembly 54. If the carousel assembly 14 is not in the correct position (where the requested storage compartment is in the open position), the mechanism control 19 transmits a signal to the motor to activate the motor such that the carousel assembly 14 rotates with respect to the motor tray until the requested compartment is aligned with the opening 48 (step 102). As the bottom carousel plate 23 travels past the signal assembly 54, the signal dimples 56 and the spaces 58 indicate which storage compartment is in the open position, or opening. This is preferably implemented via an application which correlates the presence of spaces 58 and dimples 56 being sensed with compartment identification. Alternatively, this information can be stored in a database and retrieved during the identification process.

Between each set of dimples and spaces representing a compartment identification is a set of dimples and spaces representing a lock position identification for that compartment.

As the motor is rotating, the mechanism controller 19 continues to receive signals from the switch assembly 54 indicating the information associated with the dimples 56 and spaces 58 being sensed.

For example, if a user has requested storage compartment 5 and storage compartment 3 is in the open position, the switch assembly 54 transmits an indication to the mechanism control 19 that the storage compartment 3 identification has been sensed, followed by a lock position identification for storage compartment 3 and then the storage compartment 4 identification and the lock position identification for storage compartment 4 before transmitting the storage compartment 5 identification. In the current embodiment, when the mechanism control 19 receives the storage compartment 4 identification, the controller 19 slows the rotation of the motor from 100% rotation or power to 50% rotation or power and then when the controller 19 receives the lock position for storage compartment 4, the mechanism controller 19 slows the rotation of the motor from 50% to 25% and when the mechanism controller 19 receives the storage compartment 5 identification, the mechanism controller 19 stops the motor so that storage compartment 5 is in the open position. The mechanism control 19 includes a memory or application which recognizes the relationship between storage compartment i.e. storage compartment 2 is after storage compartment 1, storage compartment 5 is after storage compartment 4 and storage compartment 1 is after storage compartment 8 or the last storage compartment. In another embodiment, there is no slowing down process and the mechanism controller 19 stops the motor once the storage compartment 5 identification is received from the switch assembly 54.

The requested storage compartment 16 can then be manually or automatically opened so that the user can access its contents.

The mechanism controller 19 is then transmitted or creates a close compartment trigger, or signal (step 104) which causes the motor to be re-activated and begin rotating the carousel assembly 14 again. Once the mechanism control 19 receives any storage compartment lock position identification, the mechanism controller 19 stops the motor. This can be achieved in the 3 step slowing down process or be an abrupt stop. The rotation of the carousel assembly 14 automatically closes the open compartment (step 106) as it contacts the lip portion 46 which also locks the open storage compartment in place so that access to all storage compartments 16 is restricted. In another embodiment, this can be assisted by the locking tabs 50. The close compartment signal can either be created from a time out signal (based on a predetermined period of time elapsed since the compartment was opened) or a proximity sensor, whereby when the user is out of range, the compartment signal is created by, or transmitted to the mechanism controller 19. Alternatively, the trigger signal can be transmitted from an RFID scanner. As will be understood, the close compartment trigger or signal causes the carousel assembly 14 to rotate so that there is no storage compartment within the open position. The mechanism controller 19 then waits for the next compartment request signal.

As will be understood, the current embodiment is useful in the field of dispensing medication. By automatically closing the compartments, thereby reducing or restricting unauthorized access to the contents, there is more security added to the dispensing process. In this manner, if a nurse, or doctor, forgets to close a storage compartment, this is automatically performed.

Furthermore, another advantage of one of the embodiments is that the footprint is reduced with respect to current dispensing mechanisms.

In yet a further embodiment, multiple mechanisms can be mounted together to provide increased storage capacity for items.

The above-described embodiments of the present invention are intended to be examples only. Alterations, modifications and variations may be effected to the particular embodiments by those of skill in the art without departing from the scope of the invention.

What is claimed is:

1. A carousel-type bin structure, having a plurality of bins arranged around a central axis, with only one bin being openable at any time, when aligned radially with a radial opening, including motor and control means for rotating the carousel to position a selected bin for opening, or to position the bins so that no bin is properly aligned with the opening, all bins thus being locked.

2. Apparatus for dispensing items comprising:
a plurality of storage compartments;
a carousel assembly for housing the plurality of storage compartments arranged around a central axis, whereby only one of the plurality of storage compartments can be open at one time;
a motor for rotating the carousel assembly; and
a mechanism control for receiving a close compartment trigger mechanism and transmitting a signal to the motor to rotate the carousel assembly to close an open storage compartment.

3. The apparatus of claim 2 further comprising:
a signal generator for transmitting a signal to the mechanism control indicating which of the plurality of storage compartments to open.

4. The apparatus of claim 2 wherein the close compartment trigger mechanism is a timer which transmits the signal after a predetermined time period has elapsed or the close compartment trigger mechanism is a proximity sensor which transmits the signal when a proximity sensor trigger is out of range.

5. The apparatus of claim 2 wherein the carousel assembly comprises:
a top carousel plate;
a bottom carousel plate, connected to the top carousel plate; and
a plurality of walls, located between the two carousel plates, defining locations for the plurality of storage compartments.

6. The apparatus of claim 5 wherein the top and bottom carousel plates include pivot points for opening and closing the plurality of storage compartments.

7. The apparatus of claim 3 further comprising a switch assembly to monitor and track which of the plurality of storage compartments is in the open position.

8. The apparatus of claim 2 further comprising:
a motor tray base, for housing the motor, including
a circular housing, for housing the carousel assembly, having a lip portion defining the circular housing for maintaining placement of the carousel assembly; and
the lip portion including an opening whereby the storage compartment can be opened.

9. The apparatus of claim 2 wherein the motor is located in a central axis of the carousel assembly.

10. A method of dispensing items comprising:
receiving a signal to open a requested storage compartment;
rotating a carousel assembly, including a plurality of storage compartments, so that the requested storage compartment is in an open position;
sensing a trigger signal indicating that the open storage compartment should be closed; and
closing the open storage compartment.

11. The method of claim 10 wherein the step of closing comprises:
rotating the carousel assembly so that the open storage compartment passes a locking tab which closes and locks the requested storage compartment.

12. The method of claim 10 wherein the trigger signal is transmitted after a predetermined period of time has elapsed after the requested storage compartment is open.

13. The method of claim 10 wherein the trigger signal is transmitted after a proximity sensor determines that a user is out of range.

14. The apparatus of claim 9 further comprising:
a pair of locking tabs adjacent the opening for closing the storage compartment as the storage compartment is rotated past one of the locking tabs.

15. The apparatus of claim 7 wherein the switch assembly is digital, mechanical or optical.
